(19) United States
(12) Patent Application Publication
(10) Pub. No.: US 2002/0085126 A1
(43) Pub. Date: Jul. 4, 2002

(54) Digital broadcasting reception unit

(75) Inventors: Osamu Matsumoto, Omihachiman-shi (JP); Sadao Kotera, Kusatsu-shi (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 10/000,987

(22) Filed: Nov. 15, 2001

(30) Foreign Application Priority Data
Nov. 15, 2000 (JP) 2000-348193

(51) Int. Cl. H04N 5/455

(52) U.S. Cl. 348/726

(57) ABSTRACT

A digital broadcasting reception unit includes a tuner unit and a demodulation unit. Analog terminals of the tuner and demodulation units are arranged in frames defined on the tuner and demodulation units near one ends of the frames, respectively, whereby a first region containing the analog terminals is formed. Digital terminals of the tuner and demodulation units are arranged in frames defined on the tuner and demodulation units near the other ends thereof, respectively, whereby a second region containing the digital terminals is formed. An analog signal wiring-pattern for connecting the analog terminals of the tuner unit to those of the demodulation unit is formed. A digital signal wiring-pattern for connecting the digital terminals of the demodulation unit to a digital signal processing circuit is formed. Furthermore, ground patterns are formed.

### BACKGROUND OF THE INVENTION

1. Field of the Invention

The present invention relates to a digital broadcasting reception unit and more particularly to a digital broadcasting reception unit which constitutes, e.g., the front end of a digital broadcasting receiver.

2. Description of the Related Art

FIG. 4 shows a digital broadcasting reception unit viewed from the back side of the mother board (not shown) for the unit. A digital broadcasting reception unit 1 contains a tuner unit 2 and a demodulation unit 3. The tuner unit 2 processes a received signal, that is, carries out the selection of a reception frequency, the alteration of the frequency, amplification, and so forth to output an IF signal. The IF signal output from the tuner unit 2 is processed in the demodulation unit 3, where the IF signal is converted to a digital signal and is output. The digital signal output from the demodulation unit 3 is processed in a digital signal processing circuit 4 for processing a signal after the demodulation.

Analog terminals 5a such as IF terminals for outputting IF signals, AGC (automatic gain control circuit) terminals, and so forth, and digital terminals 5b such as PLL (phase locking loop) terminals are formed on the under face of the tuner unit 2. Similarly, analog terminals 6a and digital terminals 6b are formed on the under face of the demodulation unit 3. The analog terminals 5a of the tuner unit 2 are connected to the analog terminals 6a of the demodulation unit 3 via wiring-pattern 7a for analog signals formed on the mother board. The digital signal output from the digital terminals 6b of the demodulation unit 3 is input to the digital signal processing unit 4 via a wiring-pattern 7b for digital signals formed on the mother board.

In the case of the tuner unit, the analog terminals and the digital terminals are arranged over the length from one end to the other end of a frame defined on the under face of the tuner unit. In this case, the positions of the analog and digital terminals are not set in such a manner that they can be distinguished from each other. Similarly, in the demodulation unit, the analog and digital terminals are arranged over the length from one end to the other end of the under face of the demodulation unit. In this case, the digital signal terminals are dominant in number. Therefore, when the tuner unit and the demodulation unit are arranged in two rows in the lateral direction on the mother board, the analog terminals of the tuner unit and the digital terminals of the demodulation unit are adjacent to each other. Thus, a digital signal interferes with an analog signal, which exerts an influence over the characteristics of the tuner.

As signals which are transmitted from the tuner unit to the demodulation unit, IF, RF, AGC signals and so forth are exemplified. The wirings of the analog signal wiring-pattern which connect the analog terminals of the tuner unit to those of the demodulation unit must be long. For this reason, digital signals from the demodulation unit and from the digital signal processing circuit as a back end are liable to disturb the tuner, which exerts influences over the reception characteristics.

Moreover, when the tuner and demodulation units of which the terminals are arranged in the way as shown in FIG. 5, respectively, are mounted on the mother board in one row, the wirings of the analog signal wiring-patterns for connecting the tuner and demodulation units to each other must be long. Thus, digital signals from the demodulation unit and the digital signal processing circuit disturb the tuner circuit via the analog signal wiring-pattern to exert influences over the characteristics of the tuner. Moreover, the wiring-patterns for outputting IF signals from the tuner must be long, and are liable to be affected by the digital signals. Furthermore, when the tuner and demodulation units are mounted on the mother board in two rows in the lateral direction as shown in FIG. 6, signals from an oscillator provided in the demodulation unit may be leaked to the outside through adjusting holes or the like to affect the characteristics of the tuner.

### SUMMARY OF THE INVENTION

Therefore, it is an object of the present invention to provide a digital broadcasting reception unit of which signals from the tuner and demodulation units are prevented from interfering with each other, and moreover, and which can avoid being affected by undesired leakage signals.

To achieve the above-described object, according to the present invention, there is provided a digital broadcasting reception unit which comprises a tuner unit and a demodulation unit which are arranged on a mother board, the tuner unit having an analog terminal row and a digital terminal row arranged on the tuner unit so as to be separated from each other, and the modulation unit having an analog terminal row and a digital terminal row arranged on the demodulation unit so as to be separated from each other.

Preferably, the tuner unit and the demodulation unit are arranged on the mother board so that the analog terminal row of the tuner unit and the analog terminal row of the demodulation unit are adjacent to each other.

Also, preferably, a first region containing the analog terminal row of the tuner unit and the analog terminal row of the demodulation unit and a second region containing the digital terminal row of the tuner unit and the digital terminal row of the demodulation unit are defined, and a ground pattern can be formed on the mother board so as to electrically separate the first region and the second region from each other.

Preferably, a first ground electrode is formed in the tuner unit, and a second ground electrode is formed in the demodulation unit, the first and second ground electrodes being arranged so as to be opposed to each other.

Since the analog terminal row and the digital terminal row in each of the tuner unit and the demodulation unit are arranged so as to be separated from each other, signals from the digital and analog terminal rows can be suppressed from interfering with each other.

Preferably, the tuner unit and the demodulation unit are arranged so that the analog terminal row of the tuner unit and the analog terminal row of the demodulation unit are adjacent to each other. Thus, the wirings of a wiring-pattern connecting the analog terminals of the analog terminal rows to each other formed on the mother board may be short.

Preferably, since the ground pattern for electrically separating the first region containing the analog terminal rows and the second region containing the digital terminal rows from each other is formed on the mother board, effects of digital signals on analog signals can be reduced, due to the shielding effects of the ground pattern.

Preferably, since the ground electrodes are formed in the units so as to be opposed to each other, effects of leakage signals generated in the demodulation unit can be reduced, due to the shielding effects of the ground electrodes.

The above-described and other objects, features, and advantages of the present invention will be more apparent from the following description of the embodiments of the present invention made with reference with the drawings.

### BRIEF DESCRIPTION OF THE DRAWINGS

FIG. 1 illustrates a digital broadcasting reception unit according to an embodiment of the present invention, viewed from the back side of the mother board (not shown) thereof;

FIG. 2 illustrates wiring-patterns for signals and ground patterns provided in the digital broadcasting reception unit shown in FIG. 1;

FIG. 3 illustrates a relation between the positions of the ground electrodes in the tuner and modulation units of a digital broadcasting reception unit according to an other embodiment of the present invention;

FIG. 4 illustrates a digital broadcasting reception unit which is viewed from the back side of the mother board (not shown) thereof;

FIG. 5 illustrates wiring-patterns for signals in another digital broadcasting reception unit; and

FIG. 6 illustrates a relation between the positions of the tuner and demodulation units in yet another broadcasting reception unit.

### DESCRIPTION OF EMBODIMENTS

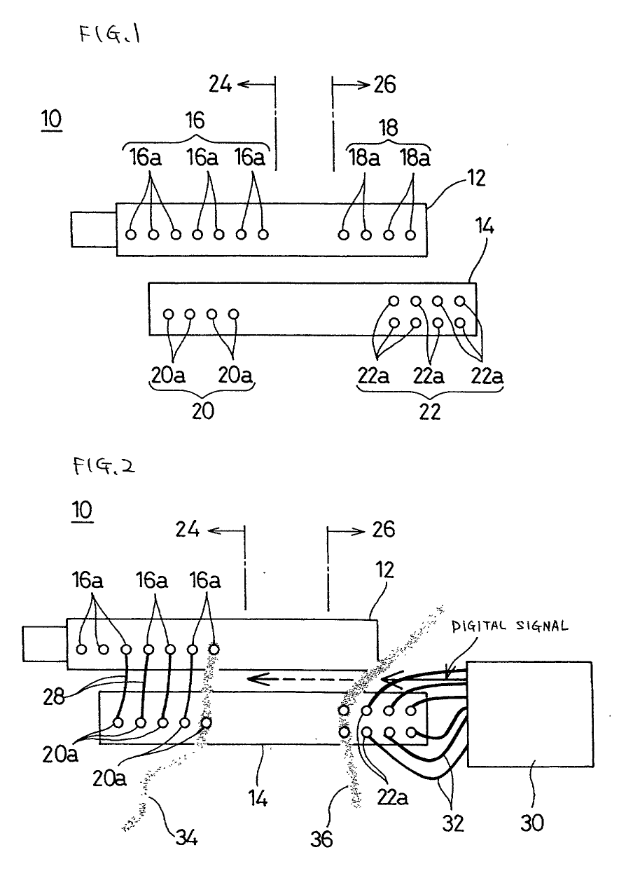

FIG. 1 shows an example of the digital broadcasting reception unit in accordance with the present invention, viewed from the back side of the mother board (not shown). A digital broadcasting reception unit 10 contains a mother board (not shown). A tuner unit 12 and a demodulation unit 14 are mounted onto the mother board. The tuner unit 12 process a received signal, that is, carries out the, selection of a reception frequency, the alteration of the frequency, amplification, and so forth to output an IF signal. The IF signal output from the tuner unit 12 is processed in the demodulation unit 14 to be converted to a digital signal, which is output from the demodulation unit 14. The digital signal output from the demodulation unit 14 is processed in a digital signal processing circuit for processing a signal after the demodulation.

An analog terminal row 16 comprising a plurality of analog terminals 16a is formed on the under face of the tuner unit 12 of the digital signal reception unit 10 near one end thereof in the longitudinal direction. Moreover, a digital terminal row 18 comprising a plurality of digital terminals 18a is formed on the under face of the tuner unit 12 near the other end thereof in the longitudinal direction. The analog terminal row 16 and the digital terminal row 18 are arranged so as to be separated from each other a distance between them.

Similarly, an analog terminal row 20 comprising a plurality of analog terminals 20a is formed on the under face of the demodulation unit 14 near one end thereof in the longitudinal direction. Moreover, digital terminal rows 22 comprising a plurality of the digital terminals 22a are formed on the under face of the demodulation unit 14 near the other end thereof in the longitudinal direction. The analog terminal row 20 and the digital terminal rows 22 are arranged so as to be separated from each other a distance between them.

In the above-described digital broadcasting reception unit 10, the tuner unit 12 and the demodulation unit 14 are arranged in two rows in the lateral direction. Thus, a first region 24 containing the analog terminal row 16 of the tuner unit 12 and the analog terminal row 20 of the demodulation unit 14 adjacent to each other is formed. Moreover, a second region 26 containing the digital terminal row 18 of the tuner unit 12 and the digital terminal row 22 of the demodulation unit 14 adjacent to each other is formed.

In the digital broadcasting reception unit 10, the analog terminal rows 16 and 20 are densely arranged in the first region 24, while the digital terminal rows 18 and 22 are densely in the second region 26. Moreover, the first region 24 and the second region 26 are distant from each other. Thus, analog and digital system signals are suppressed from interfering with each other.

An electrode pattern is formed on the mother board to connect the tuner unit 12 and the demodulation unit 14 to each other. In this case, a analog signal wiring-pattern 28 is formed on the mother board to connect the analog terminals 18a of the tuner unit 12 and the analog terminals 22a of the demodulation unit 14 to each other, as shown in FIG. 2. Moreover, a digital signal output from the demodulation unit 14 is input to a digital signal processing circuit 30 to be processed. Therefore, a digital signal wiring-pattern 32 is formed on the mother board to connect the digital signal terminals 22a of the demodulation unit 14 and the digital signal processing circuit 30 to each other.

Moreover, an analog ground pattern 34 and a digital ground pattern 36 are formed between the first region 34 containing the analog terminal rows 16 and 20 and the second region 26 containing the digital terminal rows 18 and 22. The analog ground pattern 34 is formed in the end portion of the first region 24 so as to cross the space between the first region 24 and the second region 26. The digital ground pattern 36 is formed in the end portion of the second region 26 so as to cross the space between the first region 24 and the second region 26.

In the digital broadcasting reception unit 10, the analog terminals 16a of the tuner unit 12 and the analog terminals 20a of the demodulation unit 14 are arranged adjacently to each other. Thus, the wirings of the analog signal wiring-pattern 28 on the mother board can be remarkably reduced. This suppress a digital signal from disturbing the tuner circuit via the analog signal wiring-pattern 28, which reduces effects of the digital signal on the tuner characteristics. Moreover, shield effects can be obtained by forming the analog ground pattern 34 and the digital ground pattern 36. Thus, effects of digital signals on analog signals can be reduced as shown by the arrow in FIG. 2.

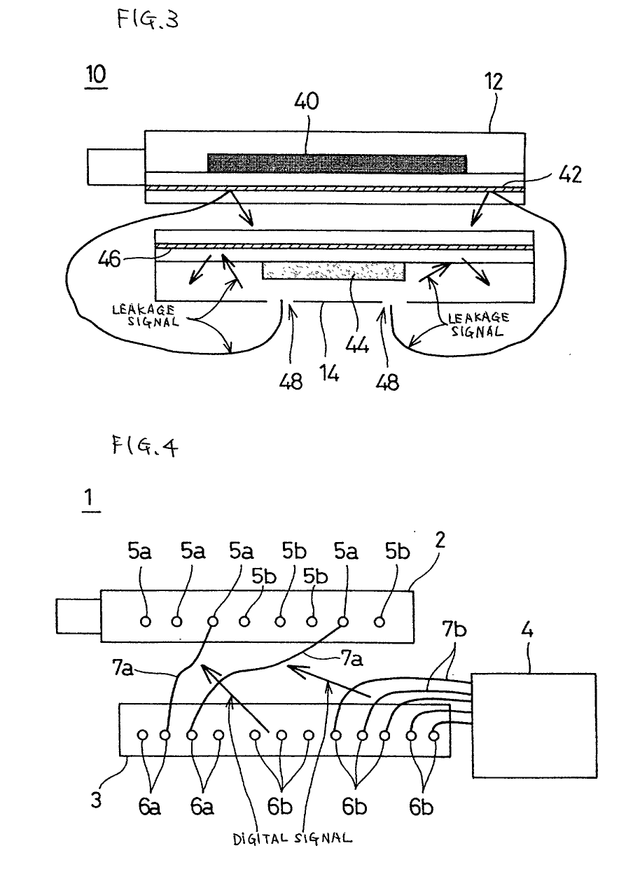

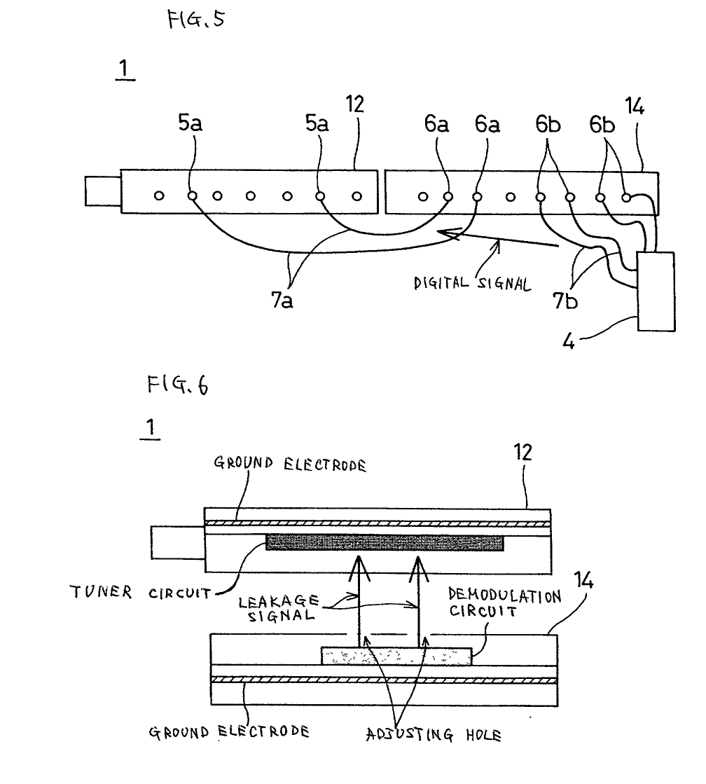

Moreover, the tuner unit 12 and the demodulation unit 14 may be arranged as shown in FIG. 3. In FIG. 3, the tuner unit 12 and the demodulation unit 14 are viewed from the upper side of the units 12 and 14 and are depicted in such a manner that the inner configurations of the units 12 and 14 can be seen. The tuner unit 12 contains a circuit 40 inside thereof, and an ground electrode 42 is formed to ground the circuit 40. Similarly, the demodulation unit 14 contains a circuit 44 inside thereof, and a ground electrode 46 is formed to ground the circuit 44.

The tuner unit 12 and the demodulation unit 14 are arranged so that the ground electrodes 42 and 46 are opposed to each other. Thus, the circuit 40 of the tuner unit 12 and the circuit 44 of the demodulation unit 14 are arranged so as to be separated from each other with the ground electrodes 42 and 46 being sandwiched between the circuits 40 and 44. Holes 48 useful for adjustment or inspection are provided with a casing of the demodulation unit 14 in the vicinity of the circuit 44 of the demodulation unit 14. That is, the holes 48 are arranged so as to be separated from the circuit 40 of the tuner unit 12 by means of the ground electrodes 42 and 46.

Shielding effects can be obtained by positioning the ground electrodes 42 and 46 so as to oppose each other. That is, digital noises leaked directly from the circuit 44 of the demodulation unit 14 and also leaked via the holes 48 are interrupted by the ground electrodes 42 and 46. As described above, the tuner unit 12 and the demodulation unit 14 can be arranged on the mother board in a layout where the units 12 and 14 are adjacent to each other, due to the ground electrodes 42 and 46 contained in the tuner unit 12 and the demodulation unit 14 used for shielding. For this reason, the area occupied by the units 12 and 14 on the mother board becomes small. Thus, the size of the mother board can be reduced.

Moreover, the holes 48 useful for adjustment and inspection provided with the casing of the demodulation unit 14 can be positioned so as to avoid facing the tuner unit 12. Thus, adjustment and inspection can be easily performed from the outside of the modulation unit 14 after the unit 12 is disposed on the mother board.

In FIG. 3, the holes 48 useful for adjustment or inspection are provided at the casing of the modulation unit. However, holes useful for adjustment or inspection may be formed in the casing of the tuner unit.

Moreover, if no holes for use in adjustment or inspection are provided with the casings of the modulation and tuner units, digital noises leaked from gaps or the like present in the casing of the modulation unit can be shielded by the ground electrodes. Thus, the same effects as described above can be obtained.

According to the present invention, the analog terminals and the digital terminals of the tuner unit and the demodulation unit are formed to be separated from each other, respectively. Thus, signals from the digital and analog terminals can be prevented from interfering with each other.

Moreover, when the tuner unit and the demodulation unit are arranged, the analog terminals of both units can be positioned adjacently to each other, due to the above-described arrangement of the terminals, so that they can be connected by means of a wiring-pattern of which the wirings are short. Thus, digital signals are suppressed from disturbing the tuner circuit via the wiring-pattern.

Furthermore, when the ground patterns are formed between the first region containing the analog terminals and the second region containing the digital terminals, deterioration of the characteristics of the tuner, caused by interference of digital signals with the tuner, can be prevented.

Moreover, when the ground electrodes formed inside the tuner units and the demodulation units are opposed to each other, deterioration of the characteristics of the tuner, caused by undesirable leakage signals, can be prevented.

What is claimed is:

1. A digital broadcasting reception unit comprising a tuner unit and a demodulation unit which are arranged on a mother board,
the tuner unit having an analog terminal row and a digital terminal row arranged thereon so as to be separated from each other, and the demodulation unit having an analog terminal row and a digital terminal row arranged thereon so as to be separated from each other.

2. A digital broadcasting reception unit according to claim 1, wherein the tuner unit and the demodulation unit are arranged on the mother board so that the analog terminal row of the tuner unit and the analog terminal row of the demodulation unit are adjacent to each other.

3. A digital broadcasting reception unit according to claim 1 or 2, wherein a first region containing the analog terminal row of the tuner unit and the analog terminal row of the demodulation unit and a second region containing the digital terminal row of the tuner unit and the digital terminal row of the demodulation unit are defined, and a ground pattern is formed on the mother board so as to electrically separate the first region and the second region from each other.

4. A digital broadcasting reception unit according to one of claims 1 to 3, wherein a first ground electrode is formed in the tuner unit, and a second ground electrode is formed in the demodulation unit, the first and second ground electrodes being arranged so as to be opposed to each other.
